(19) United States
(12) Patent Application Publication
(10) Pub. No.: US 2025/0237105 A1
(43) Pub. Date: Jul. 24, 2025

(54) GARAGE DOOR OPEN ALERT

(71) Applicant: Aravind Musuluri, Houston, TX (US)

(72) Inventor: Aravind Musuluri, Houston, TX (US)

(21) Appl. No.: 19/035,799

(22) Filed: Jan. 23, 2025

Related U.S. Application Data
(60) Provisional application No. 63/623,818, filed on Jan. 23, 2024.

(51) Int. Cl. E05F 15/77; G08B 7/06

(52) U.S. Cl. CPC E05F 15/77; E05Y 2400/446; E05Y 2400/81; E05Y 2900/106; G08B 7/06

(57) ABSTRACT

Method and systems are provided for alerting a driver of a vehicle that a garage door has been left open. The method includes: determining that a vehicle is parked inside a garage by detecting activation of an onboard transmitter in the vehicle that is configured to operate the garage door; determining that the vehicle has departed from inside the garage; processing data available at the vehicle and, based on the processing, determining that the garage door is left open; and in response to determining that the garage door is left open, providing a response selected from activating an alert device in the vehicle signaling a garage door is left open or automatically activating the onboard transmitter to close the garage door.

### CROSS REFERENCE TO RELATED APPLICATION

This application claims priority to U.S. Provisional Application Ser. No. 63/623,818 entitled Garage Door Open Alert filed on Jan. 23, 2024, which is incorporated herein by reference.

### TECHNICAL FIELD

The present disclosure generally relates to vehicle alert systems. More particularly, the present disclosure relates to a system to notify a driver that a garage door has been left open and optionally providing a mechanism to close the garage door based on driver preferences.

### BACKGROUND

Most vehicle owners prefer to keep their vehicles in a garage. Typically, a garage is equipped with an overhead garage door through which the vehicle can be moved into and out of the garage.

In some cases, a vehicle is equipped with an onboard transmitter that can be activated by a driver of the vehicle to open and close the garage door. Commonly, a driver of a vehicle may forget to activate the onboard transmitter to close the garage door upon his or her departure, thereby possibly allowing unintended access to the garage and even the rest of the house. Even more commonly, a driver may question if he or she closed the garage door, often necessitating a return trip to check.

U.S. Pat. No. 8,115,616 discloses a method for alerting a driver of a vehicle that a garage door has not been closed. However, the method requires GPS circuitry to be installed in the vehicle to determine the location of the vehicle, which not only adds additional costs to the vehicle but also adds weight to the vehicle there by reducing fuel economy of the vehicle.

Another drawback of the existing location based alerting method is that the driver is alerted even when the vehicle is parked outside a garage, for example, in a driveway, and departs from outside of the garage.

In view of the above drawbacks, there remains a need for an effective method and system for alerting a driver that the garage door has been left open.

### SUMMARY

The following presents a simplified summary of the disclosure in order to provide a basic understanding to the reader. This summary is not an extensive overview of the disclosure and it does not identify key/critical elements of the disclosure or delineate the scope of the disclosure. Its sole purpose is to present some concepts disclosed herein in a simplified form as a prelude to the more detailed description that is presented later.

According to an embodiment, a method for alerting a driver of a vehicle that a garage door has not been signaled to close is provided. The method includes: determining that a vehicle is parked inside a garage by detecting activation of an onboard transmitter in the vehicle that is configured to operate the garage door; processing data available at the vehicle after the vehicle departed from inside the garage and, based on the processing, determining that the garage door is left open; and in response to the determining that the garage door is left open, activating an alert device in the vehicle signaling a garage door is left open and/or automatically activating the onboard transmitter to close the garage door.

In another aspect of the present disclosure is provided with a system comprising of processing hardware and memory configured to perform the functions and operations associated with the above disclosed methods.

### BRIEF DESCRIPTION OF THE DRAWINGS

The drawings described herein are for illustration purposes only and are not intended to limit the scope of the present disclosure in anyway. Throughout the disclosure, like elements are represented by like reference numerals, which are given by way of illustration only and thus are not limitative of the various embodiments.

Other objects and advantages of the present disclosure will become apparent to those skilled in the art upon reading the following detailed description of the preferred embodiments, in conjunction with the accompanying drawings, wherein:

FIG. 1 is a simplified diagram of an exemplary system for alerting a driver of a vehicle that a garage door has not been closed.

FIGS. 2 and 3 are flow charts illustrating exemplary methods for determining whether a vehicle is parked inside a garage.

FIG. 4 is a flow chart illustrating an exemplary method for alerting a driver of a vehicle that the garage door has not been closed.

### DETAILED DESCRIPTION

The following detailed description is merely exemplary in nature and is not intended to limit the invention or the application and uses of the invention. Furthermore, there is no intention to be bound by any expressed or implied theory presented in the preceding technical field, background, brief summary or the following detailed description.

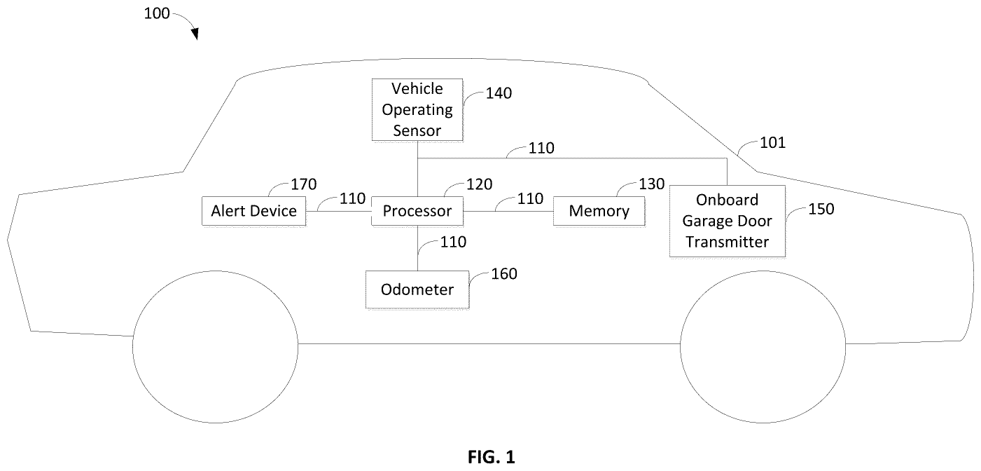

FIG. 1 is a block diagram of a system 100 for alerting a driver (not shown) when a garage door (not shown) has been left open. In the exemplary embodiment, system 100 is implemented in a vehicle 101 and suitably includes a processor 120 having a first input coupled to memory module 130 for receiving stored values and instructions, a second input coupled to vehicle operating sensor 140 for receiving an indication of vehicle operating state, a third input coupled to onboard garage door transmitter 150 for receiving an indication when onboard transmitter 150 is activated, and a fourth input coupled to odometer 160 for measuring distance traveled by vehicle 101. Processor 120 has a first output coupled to memory module 130 for storing values and instructions, a second output coupled to activate alert device 170, and a third output coupled to onboard garage door transmitter 150.

In the exemplary embodiment, system 100 may include a bus 110. Bus 110 may include a path that permits communication among the components of system 100.

In the exemplary embodiment, processor 120 is any type of device, or multiple devices, capable of manipulating or processing information.

Onboard transmitter 150 is configured to operate the garage door and when activated the onboard transmitter 150 sends a signal to open/close the garage door. Onboard transmitter has a signal transmission range, and when the onboard transmitter is within the signal transmission range it can operate the garage door.

In the exemplary embodiment, odometer 160 detects and counts rotations of vehicle 101 wheel. It sends wheel rotation data to processor 120 via bus 110. Since the diameter of vehicle 101 tires is known in advance and stored in the memory module 130, counting the number of wheel revolutions or fractions (preferably fraction ( 1/24)^{th} to fraction ( 1/48)^{th}) thereof using data from odometer 160 enables processor 120 to calculate a relatively precise distance travelled by vehicle 101 simply by multiplying wheel revolutions by vehicle 101 tire circumference. Note that in another embodiment, one or more devices or sensors alone or in combination whose value increases or decreases as vehicle 101 travels may be used as odometer 160. For example, these devices or sensors may be, but not limited to, radar device, GPS device, time sensor, a fuel flow sensor, and/or a speedometer.

In the exemplary embodiment processor 120 uses the activation of the onboard transmitter 150 in at least two ways. First, processor 120 determines that vehicle 101 is parked inside a garage by the activation of onboard transmitter 150. Second, if vehicle 101 is departing from inside the garage, processor 120 alerts the driver that the garage door has been left open if onboard transmitter 150 is not activated to close the garage door.

In the exemplary embodiment, processor 120 may infer vehicle operating state from vehicle operating sensor 140. In the exemplary embodiment, vehicle 101 is operating if vehicle operating sensor 140 detects vehicle 101 gear is not in a parked position and vice versa. Note that vehicle operating sensor 140 may detect vehicle operating state in a variety of ways. For example, in other embodiments, vehicle operating sensor 140 may detect vehicle operating state based on a characteristic of vehicle 101, such as engine state, key position in an ignition switch, vehicle not moving for a predetermined amount of time etc.

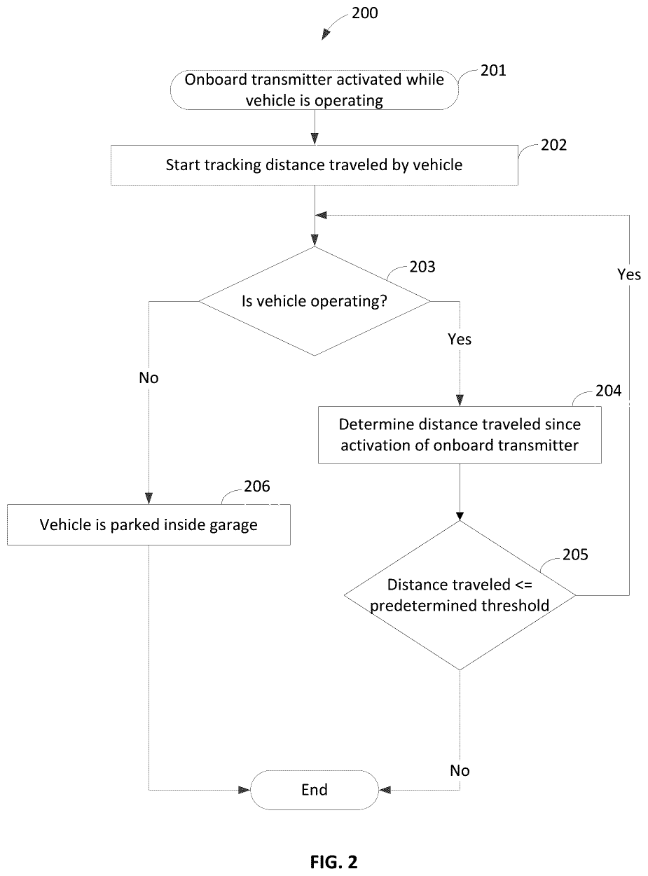

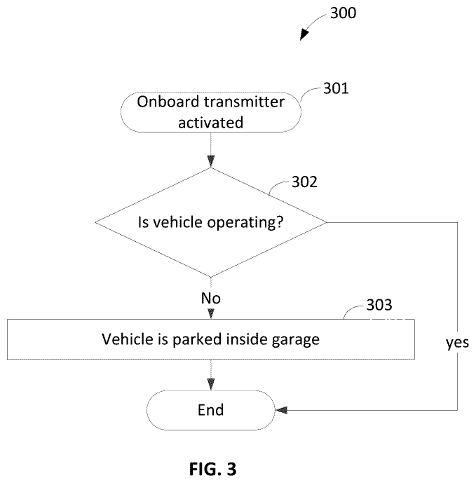

In the exemplary embodiment, processor 120 determines that vehicle 101 is parked inside a garage by detecting activation of onboard transmitter 150 by a driver of vehicle 101 to open the garage door to park vehicle 101 inside the garage and/or close/open the garage door after vehicle 101 is parked inside the garage. Determining by processor 120 that vehicle 101 is parked inside a garage is further described in FIGS. 2 and 3. Processor 120 may store an indication that vehicle 101 is parked inside the garage in memory module 130.

If vehicle 101 is departing from inside the garage, processor 120 uses data from odometer 160 to track distance traveled by vehicle 101 from the garage, up to a predetermined threshold. In the exemplary embodiment, the predetermined threshold is based on the onboard transmitter range and stored in memory module 130. For example, the predetermined threshold may be 50% of onboard transmitter range. In a preferred embodiment, the predetermined threshold may be set by a driver of vehicle 101 through an interface (not shown) and stored in memory module 130. Processor 120 compares the current distance traveled by vehicle 101 with the stored predetermined threshold to determine if vehicle 101 has traveled the predetermined threshold distance. Processor 120 monitors the distance traveled by vehicle 101 at regular intervals to determine when vehicle 101 has reached the predetermined threshold distance. If onboard transmitter 150 sends a signal to close the garage door before vehicle 101 reaches the predetermined threshold distance, then processor 120 determines that the garage door alert is not needed. If a signal to close the garage door has not been sent, in one embodiment, processor 120 alerts the driver that the garage door is open using driver alert device 170. In another embodiment, processor 120 closes the garage door by activating onboard transmitter 150. Further, processor 120 may remove the indication that the vehicle is parked inside the garage from memory module 130.

Driver alert device 170 communicates the garage door open alert to the driver using indicators such as lights, images, sounds, or vibrations. In this manner driver alert device 170 produces an audible alarm, an audible voice prompt, a visual alert, or a tactile stimulation alert. The garage door open alert continues for a set interval, unless the driver activates the garage door transmitter 150, or the driver cancels the garage door open alert.

Turning now to FIGS. 2 and 3, there are shown exemplary methods 200 and 300 for determining whether a vehicle is parked inside a garage. The steps or functionality of flowcharts 200 and 300 may be stored in memory module 130 (FIG. 1) and accessible by processor 120 (FIG. 1).

In the exemplary method 200, processor 120 (FIG. 1) determines that vehicle 101 (FIG. 1) is parked inside a garage by detecting activation of onboard transmitter 150 (FIG. 1) by a driver to open the garage door to park vehicle 101 inside the garage. In step 201, method 200 begins when processor 120 receives a signal from onboard transmitter 150 indicating activation of onboard transmitter 150 while vehicle 101 is operating. In step 202, immediately after the activation of onboard transmitter 150, processor 120 starts tracking distance traveled by vehicle 101 using odometer 160 (FIG. 1). In step 203, at regular intervals processor 120 monitors vehicle operating state using vehicle operating sensor 140 and proceeds to step 204 if vehicle 101 is operating. In step 204, processor 120 determines distance traveled by vehicle 101 since the activation of onboard transmitter 150. In step 205, the distance traveled by vehicle 101 is compared with a predetermined threshold stored in memory module 130. If the distance traveled by vehicle 101 is less than or equal to the predetermined threshold, then the driver may still be parking the vehicle in the garage. Therefore, processor 120 continues to monitor the vehicle operating state (step 203). In step 205, if the distance traveled since the activation of onboard transmitter 150 is greater than the predetermined threshold, then the exemplary method ends ignoring the activation of onboard transmitter 150 in step 201. In step 203, if the vehicle stopped operating, processor 120 determines vehicle 101 is parked inside the garage (step 206) and then ends. Additionally, in step 206, processor 120 may store data in memory module 130 indicative of vehicle 101 is parked inside the garage.

In the exemplary embodiment 200, the predetermined threshold is based on onboard transmitter 150 (FIG. 1) signal transmission range. In the exemplary embodiment, the predetermined threshold is equal to onboard transmitter 150 signal transmission range.

In the exemplary method 300, processor 120 (FIG. 1) determines that vehicle 101 (FIG. 1) is parked inside a garage by detecting activation of onboard transmitter 150 (FIG. 1) to open/close the garage door after the vehicle 101 is parked inside the garage. In step 301, method 300 begins when processor 120 receives a signal from onboard transmitter 150 indicating activation of the onboard transmitter. In step 302, immediately after activation of onboard transmitter 150, processor 120 infers the operating state of vehicle 101 from vehicle operating sensor 140 and determines that vehicle 101 is parked inside the garage (step 303) if vehicle 101 is not operating. Additionally, in step 303, processor 120 may store data in memory module 130 indicative of vehicle 101 is parked inside the garage. In step 302, if vehicle 101 is operating, then the exemplary method ends.

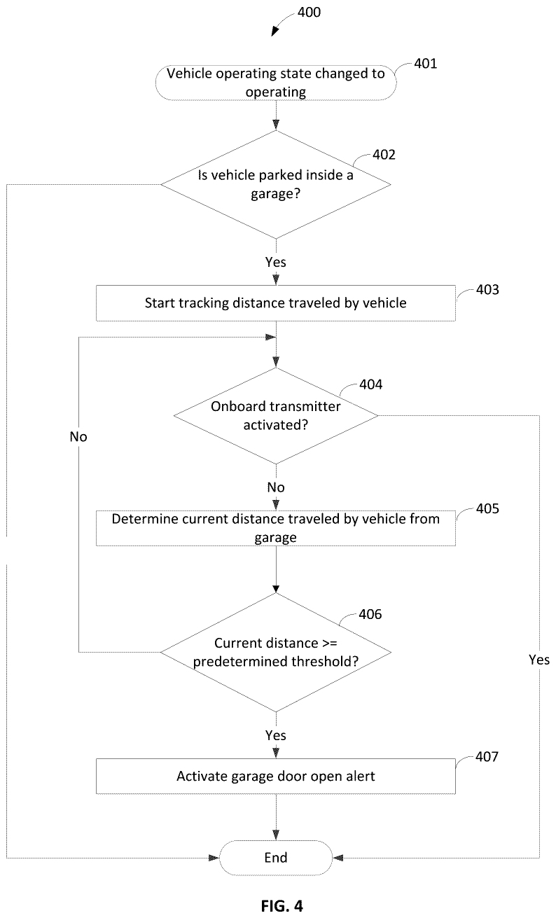

Turning now to FIG. 4, there is shown an exemplary method 400 for alerting a driver that a garage door of a garage is open. The steps or functionality of flowchart 400 may be stored in memory module 130 (FIG. 1) and accessible by processor 120 (FIG. 1). In step 401, method 400 begins when processor 120 receives a signal from vehicle operating sensor 140 indicating vehicle 101 operating state changed from not operating to operating. As described hereinabove, memory module 130 stores information indicative of whether vehicle 101 is inside the garage. In step 402, processor 120 reads data stored in memory module 130 and determines that vehicle 101 is departing from inside the garage if the data stored in memory module 130 is indicative of vehicle 101 is parked inside the garage. In step 402, if vehicle 101 is not departing from inside the garage, then the exemplary method ends. In step 403, immediately after determining that vehicle 101 is departing from inside the garage, processor 120 starts tracking distance traveled by vehicle 101 using odometer 160 (FIG. 1). In step 404, processor 120 monitors activation of onboard transmitter 150 (FIG. 1) to determine if it is activated. If onboard transmitter 150 is activated in step 404, processor 120 determines that the garage door alert is not need and ends the exemplary method. In step 404, at regular intervals, processor 120 proceeds to step 405 if onboard transmitter 150 is not activated. In step 405, processor 120 determines distance traveled by vehicle 101 since vehicle 101 is in the garage. In step 406, the distance traveled by vehicle 101 is compared with a predetermined threshold stored in memory module 130. If the distance traveled by vehicle 101 is less than the predetermined threshold, then the driver has not left the area near the garage and may still activate onboard transmitter 150 to close the garage door. Therefore, processor 120 continues to monitor activation of onboard transmitter 150 (step 404). In step 406, if the distance traveled by vehicle 101 is greater than or equal to the predetermined threshold, processor 120 alerts the driver that the garage door is open using driver alert device 170 (FIG. 1) (step 407) and then ends. In step 407, alert device may be activated for a time period or until the onboard transmitter 150 has been activated to close the garage door.

In the exemplary embodiment 400, the predetermined threshold is based on onboard transmitter 150 (FIG. 1) signal transmission range. In a preferred embodiment, the predetermined threshold is equal to 75% of onboard transmitter 150 signal transmission range. In another embodiment, the predetermined threshold is equal to onboard transmitter 150 signal transmission range.

Note that in other embodiments, processor 120 (FIG. 1) may perform the steps or functions described in methods 200, 300 and 400 in a different order and may execute functions simultaneously. Additional functions may be added or removed, and methods 200, 300 and 400 may be part of a larger process, or multiple processes.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing the exemplary embodiment or exemplary embodiments. It should be understood that various changes can be made in the function and arrangement of elements without departing from the scope of the invention as set forth in the appended claims and the legal equivalents thereof.

1. A method for alerting a driver or closing a garage door that has not been signaled to close, the method comprising:
(a) determining that a vehicle is parked inside a garage by detecting activation of an onboard transmitter in the vehicle that is configured to operate the garage door;
(b) processing data available at the vehicle after the vehicle departed from inside the garage and, based on the processing, determining that the garage door is left open; and
(c) in response to the determination in step (b), activating an alert device in the vehicle signaling a garage door is left open and/or activating the onboard transmitter to close the garage door.

2. The method of claim 1, wherein step (a) further comprises determining that the activation of the onboard transmitter is performed while the vehicle is operating.

3. The method of claim 2, further comprises determining that the distance traveled by the vehicle since the activation of onboard transmitter to the vehicle operating state changing to not operating is less than a threshold.

4. The method of claim 3, wherein the threshold is based on the onboard transmitter range.

5. The method of claim 1, wherein step (a) further comprises determining that the activation of the onboard transmitter is performed while the vehicle is not operating.

6. The method of claim 1, wherein step (b) further comprises monitoring a distance traveled by the vehicle from the garage, and determining that the distance traveled by the vehicle reached a threshold and the onboard transmitter has not been activated to close the garage door.

7. The method of claim 6, wherein the threshold is based on the onboard transmitter range.

8. The method of claim 1, wherein the alert device is activated for a time period or until the onboard transmitter has been activated to close the garage door.

9. The method of claim 1, wherein the alert device in the vehicle is configured to produce one or more of an audible alarm, an audible voice prompt, a visual alert, or a tactile stimulation alert.

10. A system for alerting a driver or closing a garage door that has not been signaled to close, the system comprising: a processor; an onboard transmitter coupled to the processor, configured to operate the garage door when activated; an alert device coupled to the processor when activated, configured to produce one or more of an audible alarm, an audible voice prompt, a visual alert, or a tactile stimulation alert to alert the driver of the vehicle; and a non-transitory memory module coupled to the processor and storing program instructions for the processor, which when executed causes the processor to:
(a) determine, by the processor, that the vehicle is inside the garage by detecting activation of the onboard transmitter;
(b) process data available at the vehicle after the vehicle departed from the garage, and based on the processing, determine that the garage door is left open; and
(c) in response to the determination in step (b), said program instructions cause the processor to activating an alert device and/or activating the onboard transmitter to close the garage door.

11. The system of claim 10, further comprises a vehicle operating sensor coupled to the processor, configured to sense the vehicle operating state as operating or not operating; and wherein the non-transitory memory module stores additional program instructions, which when executed cause the processor to: determine that the vehicle is parked inside the garage if the activation of the onboard transmitter is performed while the vehicle is operating.

12. The system of claim 11, further comprises a odometer coupled to the processor, configured to measure distance traveled by the vehicle; and wherein the non-transitory memory module stores additional program instructions, which when executed cause the processor to: determine that the vehicle is parked inside the garage if the distance traveled by the vehicle since the activation of onboard transmitter to the vehicle operating state changing to not operating is less than a threshold.

13. The system of claim 12, wherein the threshold is based on the onboard transmitter range.

14. The system of claim 10, further comprises a vehicle operating sensor coupled to the processor, configured to sense the vehicle operating state as operating or not operating; and wherein the non-transitory memory module stores additional program instructions, which when executed cause the processor to: determine that the vehicle is parked inside the garage if the activation of the onboard transmitter is performed while the vehicle is not operating.

15. The system of claim 10, further comprises a odometer coupled to the processor, configured to measure distance traveled by the vehicle; and wherein the non-transitory memory module stores additional program instructions, which when executed cause the processor to: monitor a distance traveled by the vehicle since the vehicle departed from the garage, and determine that the garage door is left open if the distance traveled reached a threshold and the onboard transmitter has not been activated to close the garage door.

16. The system of claim 15, wherein the threshold is based on the onboard transmitter range.

17. The system of claim 10, wherein the alert device is activated by the program instructions for a time period or until the onboard transmitter has been activated to close the garage door.

18. The system of claim 10, wherein the alert device in the vehicle is configured to produce one or more of an audible alarm, an audible voice prompt, a visual alert, or a tactile stimulation alert.
